(19) United States
(12) Patent Application Publication
(10) Pub. No.: US 2025/0044535 A1
(43) Pub. Date: Feb. 6, 2025

(54) PHOTONIC HYBRID RECEIVER AND MODULATOR CIRCUITS AND METHODS

(71) Applicant: WHALEPIX INC., QUÉBEC (CA)

(72) Inventors: WEI SHI, QUEBEC (CA); MOHAMMAD AHMADI, OTTAWA (CA); HASSAN SEPEHRIAN, OTTAWA (CA)

(21) Appl. No.: 18/791,596

(22) Filed: Aug. 1, 2024

Related U.S. Application Data
(60) Provisional application No. 63/657,273, filed on Jun. 7, 2024.
(60) Provisional application No. 63/571,651, filed on Mar. 29, 2024.
(60) Provisional application No. 63/517,005, filed on Aug. 1, 2023.

(51) Int. Cl. G02B 6/42; G02F 1/01

(52) U.S. Cl. CPC G02B 6/4273; G02B 6/4213; G02B 6/4246; G02F 1/0113; G02F 2201/127; G02F 2203/50

(57) ABSTRACT

Photonics has become a dominant or evolving technological solution for communications to meet the increasing demand for bandwidth. Accordingly, photonic communications is moving towards coherent modulation formats to further increase capacity by encoding information in both phase and amplitude of the optical signal. Whilst coherent optical transmitters and coherent optical receivers are more complex than their on-off counterparts leveraging monolithic photonic elements and photonic integrated circuits employing said photonic elements offers a lower cost route for coherent optical components. Further, external modulation, using phase modulators or amplitude modulators or a combination thereof, can increase modulation bandwidth relative to directly modulated lasers for increased data transmission. Novel optical hybrid circuits and external modulators are present which are compatible photonic integrated circuit manufacturing techniques and monolithic integration.

### CROSS-REFERENCE TO RELATED APPLICATIONS

This patent application claims the benefit of priority to U.S. Provisional Patent Application 63/517,005 filed Aug. 1, 2023, the entire contents of which are incorporated herein by reference.

This patent application claims the benefit of priority to U.S. Provisional Patent Applications 63/571;651 filed Mar. 29, 2024.

This patent application claims the benefit of priority to U.S. Provisional Patent Applications 63/657,273 filed Jun. 7, 2024.

### FIELD OF THE INVENTION

This invention is directed to photonic circuits and more particularly to photonic hybrid circuits for coherent optical receivers and photonic modulators for optical transmitters.

### BACKGROUND OF THE INVENTION

Photonics has become a dominant or evolving technological solution in a wide range of applications from sensing, biomedical sensing, to quantum computing, quantum sensing, and telecommunications. Within communications streaming media, mobile data traffic, and cloud computing continue to fuel an increasing demand for bandwidth. In order to meet this demand, photonic communications are moving towards coherent modulation formats to further increase capacity. Compared to conventional on-off keying modulation formats within current optical communications networks coherent modulation formats encode information in both phase and amplitude of the optical signal.

However, coherent optical transmitters and coherent optical receivers are more complex than their on-off counterparts. Accordingly, it would be beneficial to provide such systems with photonic elements and photonic integrated circuits employing said photonic elements as these offer the potential to lower the cost of coherent optical components by virtue of leveraging hybrid and/or monolithic integration with semiconductor level manufacturing cost profiles and techniques.

Accordingly, the inventors have established a novel optical hybrid circuit which is compatible with such photonic integrated circuit manufacturing techniques with potential for monolithic integration of a complete coherent receiver. The novel optical hybrid circuit also supports on-wafer level testing prior to die separation to further enhance manufacturing processes and reduce costs.

Further, external modulation of a continuous wave (CW) laser can provide increased modulation bandwidth relative to that of a directly modulated laser for further increasing data transmission. Such external modulators can be phase modulators or amplitude modulators or a combination thereof. However, in most materials a velocity mismatch between the optical and electrical signals must be compensated for to achieve the desired bandwidth and increased device length to reduce drive voltage. Within silicon photonics this requires slowing the optical signal. Accordingly, it would be beneficial to achieve this without increasing the optical loss of the modulator.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to photonic circuits and more particularly to photonic hybrid circuits for coherent optical receivers and photonic modulators for optical transmitters.

In accordance with an embodiment of the invention there is provided an optical circuit comprising:
an adiabatic coupler having a pair of input ports and a pair of output ports;
a first coupler having an input port coupled to an output port of the pair of output ports of the adiabatic coupler;
a second coupler having an input port coupled to another output port of the pair of output ports of the adiabatic coupler; and
a third coupler having a pair of input ports and a pair of output ports; wherein an output port of the pair of output ports of the third coupler is coupled to another input port of the first coupler;
another output port of the pair of output ports of the third coupler is coupled to another input port of the second coupler;
a pair of output ports of the first coupler are coupled to a first balanced photodetector; and
a pair of output ports of the second coupler are coupled to a second balanced photodetector.

In accordance with an embodiment of the invention there is provided a method of receiving optical data comprising:
providing an optical circuit comprising a pair of optical hybrid circuits each comprising:
   an adiabatic coupler having a pair of input ports and a pair of output ports;
   a first coupler having an input port coupled to an output port of the pair of output ports of the adiabatic coupler;
   a second coupler having an input port coupled to another output port of the pair of output ports of the adiabatic coupler; and
   a third coupler having a pair of input ports and a pair of output ports; wherein
   an output port of the pair of output ports of the third coupler is coupled to another input port of the first coupler;
   another output port of the pair of output ports of the third coupler is coupled to another input port of the second coupler;
   a pair of output ports of the first coupler are coupled to a first balanced photodetector; and
   a pair of output ports of the second coupler are coupled to a second balanced photodetector
providing a splitter coupled to a laser emitting at a predetermined wavelength with a predetermined polarisation wherein a first output of the splitter is coupled to an input port of the pair of input ports of the adiabatic coupler within an optical hybrid circuit of the pair of optical hybrid circuits and a second output of the splitter is coupled to an input port of the pair of input ports of the adiabatic coupler within the other optical hybrid circuit of the pair of optical hybrid circuits;
providing a polarisation splitter and rotator (PSR) circuit coupled to a network for receiving an optical signal at the predetermined wavelength wherein a first output of the PSR circuit is split from the received optical signal with the PSR circuit has the predetermined polarisation and is coupled to an input port of the third coupler of an optical hybrid circuit of the pair of optical hybrid circuits and a second output of the PSR circuit is split from the received optical signal with an orthogonal polarisation to the predetermined polarisation and rotated to the predetermined polarisation prior to becoming the second output of the PSR circuit and is coupled an input port of the third coupler within the other optical hybrid circuit of the pair of optical hybrid circuits.

In accordance with an embodiment of the invention there is provided an optical circuit comprising:
an adiabatic coupler having a pair of input ports and a pair of output ports;
a first coupler having an input port coupled to an output port of the pair of output ports of the adiabatic coupler;
a second coupler having an input port coupled to another output port of the pair of output ports of the adiabatic coupler; and
a third coupler having a pair of input ports and a pair of output ports; wherein
an output port of the pair of output ports of the third coupler is coupled to another input port of the first coupler; and
another output port of the pair of output ports of the third coupler is coupled to another input port of the second coupler.

In accordance with an embodiment of the invention there is provided a device comprising:
an optical waveguide;
a travelling wave electrode for inducing a phase shift to an optical signal propagating within the optical waveguide comprising a plurality of contacts disposed along a section of the optical waveguide; wherein
the optical waveguide has a periodic offset by a mathematical function along the length of the section of the optical waveguide from an overall path of the optical waveguide which is defined by another mathematical function over the length of the section of the optical waveguide; and
the period of the periodic offset is defined in dependence upon a spacing between adjacent pairs of contacts of the plurality of contacts.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a polarisation diverse coherent receiver according to the prior art;

FIG. 2 depicts an optical hybrid circuit for a coherent receiver according to the prior art;

FIG. 3 depicts an optical hybrid circuit for a coherent receiver according to an embodiment of the invention;

FIG. 4 depicts a polarisation diverse coherent receiver according to an embodiment of the invention employing the inventive optical hybrid circuits depicted in FIG. 3;

FIG. 5 depicts an optical hybrid circuit for a coherent receiver according to an embodiment of the invention;

FIG. 6 depicts an optical hybrid circuit for a coherent receiver according to an embodiment of the invention; and

FIG. 7 depicts a phase matching method according to an embodiment of the invention for a travelling wave modulator.

### DETAILED DESCRIPTION

The present invention is directed to photonic circuits and more particularly to photonic hybrid circuits for coherent optical receivers and photonic modulators for optical transmitters.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It would be understood by one of skill in the art that various changes can be made in the function and arrangement of elements without departing from the scope of the invention as set forth in the claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment,” “an embodiment,” “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purposes only. It is to be understood that where the claims or specification refer to “a” or “an” element, such reference is not to be construed as there being only one of that element. It is to be understood that where the specification states that a component feature, structure, or characteristic “may,” “might,” “can” or “could” be included, that particular component, feature, structure, or characteristic is not required to be included.

Reference to terms such as “left,” “right,” “top,” “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including,” “comprising,” “consisting” and grammatical variants thereof do not preclude the addition of one or more components, features, steps, integers or groups thereof and that the terms are not to be construed as specifying components, features, steps or integers. Likewise, the phrase “consisting essentially of,” and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional elements.

A “two-dimensional” waveguide, also referred to as a 2D waveguide or a planar waveguide, as used herein may refer to, but is not limited to, an optical waveguide supporting propagation of optical signals within a predetermined wavelength range which does not guide the optical signals laterally relative to the propagation direction of the optical signals.

A “three-dimensional” waveguide, also referred to as a 3D waveguide, a channel waveguide, or simply waveguide as used herein may refer to, but is not limited to, an optical waveguide supporting propagation of optical signals within a predetermined wavelength range which guides the optical signals laterally relative to the propagation direction of the optical signals.

A “photonic integrated circuit” (PIC) as used herein may refer to, but is not limited to, the monolithic integration of multiple integrated optics devices into a circuit formed upon a common substrate providing an optical routing and processing functionality. The PIC is fabricated using processing techniques at a wafer level, e.g., CMOS manufacturing flows, MEMS processing flows, etc.

An “adiabatic coupler” as used herein may refer to, but is not limited to, an optical coupler which adiabatically converts the mode of an input optical waveguide into either the even or odd mode of two or more optical waveguides separated by small gap(s). An adiabatic coupler may therefore be a non-zero gap symmetric directional coupler or a non-zero gap asymmetric directional coupler for example.

Within embodiments of the invention the inventors may refer to the term “hybridly integrated.” This may, within some embodiments of the invention, refer to, but not be limited to, the “integration” of an optical element onto a substrate by attaching the optical element or another element physically integrated with the optical element to the substrate (platform) such that the optical element is retained in position. Such attachment means may include, but not be limited to, soldering, epoxy, van der Waals forces, electrostatic attachment, magnetic attachment, physical interlocking and friction. Accordingly, in these embodiments of the invention the optical element being hybridly integrated may be viewed as being implemented within a parallel manufacturing process to the other optical element(s) prior to being co-assembled. This parallel manufacturing process may employ one or more processes selected from the group comprising, but not limited to, liquid phase epitaxy (LPE), metal organic chemical vapor deposition (MOCVD), organometallic vapour-phase epitaxy (OMVPE), selective area epitaxy, an additive manufacturing process, a non-additive manufacturing process, crystal growth, doping, induced damage, etching, doping and deposition.

This may, within other embodiments of the invention, refer to, but not be limited to, the “integration” of an optical element onto a substrate using a different manufacturing methodology and/or techniques to those employed in forming other optical components upon the substrate. For example, this may employ employing a LPE process to form the other optical element upon the substate wherein the optical component upon the substrate was formed by MOCVD or vice-versa. Alternatively, both the optical component and other optical component may be formed using the same manufacturing methodology or a combination of manufacturing methodologies. These manufacturing methodologies may employ one or more processes selected from the group comprising, but not limited to, LPE, MOCVD, OMVPE, selective area epitaxy, an additive manufacturing process, a subtractive manufacturing process, a non-additive manufacturing process, crystal growth, doping, induced damage, etching, doping, and deposition

Within the embodiments of the invention the inventors refer to the terms “hybridly integrated” and “hybrid integration.” This may, within some embodiments of the invention, refer to, but not be limited to, the “integration” of an optical element onto a substrate by attaching the optical element or another element physically integrated with the optical element to the substrate (platform) such that the optical element is retained in position. Such attachment means may include, but not be limited to, soldering, epoxy, van der Waals forces, electrostatic attachment, magnetic attachment, physical interlocking and friction. Accordingly, in these embodiments of the invention the optical element being hybridly integrated may be viewed as being implemented within a parallel manufacturing process to the other optical element(s) prior to being co-assembled. This parallel manufacturing process may employ one or more processes selected from the group comprising, but not limited to, liquid phase epitaxy (LPE), metal organic chemical vapor deposition (MOCVD), organometallic vapour-phase epitaxy (OMVPE), selective area epitaxy, an additive manufacturing process, a non-additive manufacturing process, crystal growth, doping, induced damage, etching, doping and deposition.

Within the embodiments of the invention the inventors refer to the terms “monolithically integrated” and “monolithic integration.” This may, within some embodiments of the invention, refer to, but not be limited to, the “integration” of an optical element onto a substrate by directly forming the optical element upon a substrate (platform). The optical element may be one of a series of optical elements formed upon the substrate to form an optical component or optical circuit. These optical elements may be optical waveguides themselves, be interconnected by optical waveguides, be interconnected by other optical elements formed upon the substrate through a subsequent processing step or stage or interconnected via other optical elements hybridly integrated onto the substrate. Accordingly, these monolithically integrated optical elements, e.g. optical waveguides, in these embodiments of the invention may employ one or more manufacturing processes selected from the group comprising, but not limited to, liquid phase epitaxy (LPE), metal organic chemical vapor deposition (MOCVD), organometallic vapour-phase epitaxy (OMVPE), selective area epitaxy, photolithography, direct writing, ion beam milling, an additive manufacturing process, a non-additive manufacturing process, crystal growth, doping, induced damage, chemical etching, reactive ion etching (RIE), plasma etching, sputter etching, ion beam assisted etching, reactive ion beam etching, lift-off and deposition.

A “ceramic” as used herein may refer to, but is not limited to, an inorganic, nonmetallic solid material comprising metal, non-metal or metalloid atoms primarily held in ionic and covalent bonds. Such ceramics may be crystalline materials such as oxide, nitride or carbide materials, elements such as carbon or silicon, and non-crystalline. Exemplary ceramics may include high temperature ceramics or high temperature co-fired ceramics such as alumina (Al2O3), zirconia (ZrO2), and aluminum nitride (AlN) or a low temperature cofired ceramic (LTCC). A LTCC may be formed from a glass—ceramic combination.

A “metal” or “alloy” as used herein may refer to, but is not limited to, a material having good electrical and thermal conductivity. Metals are generally malleable, fusible, and ductile. Metals as used herein may refer to elements such as gold, silver, copper, aluminum, iron, etc. whilst an alloy as used herein refers to a combination of metals such as bronze, stainless steel, steel etc.

A “polymer” as used herein may refer to, but is not limited to, is a large molecule, or macromolecule, composed of many repeated subunits. Such polymers may be natural and synthetic and typically created via polymerization of multiple monomers. Polymers through their large molecular mass may provide unique physical properties, including toughness, viscoelasticity, and a tendency to form glasses and semi-crystalline structures rather than crystals.

A “glass” as used herein may refer to, but is not limited to, a non-crystalline amorphous solid. A glass may be fused quartz, silica, a soda-lime glass, a borosilicate glass, a lead glass, an aluminosilicate glass for example. A glass may include other inorganic and organic materials including metals, aluminates, phosphates, borates, chalcogenides, fluorides, germanates (glasses based on GeO2), tellurites (glasses based on TeO2), antimonates (glasses based on Sb2O3), arsenates (glasses based on As2O3), titanates (glasses based on TiO2), tantalates (glasses based on Ta2O5), nitrates, carbonates, plastics, and an acrylic.

Embodiments of the invention may be implemented within one or more semiconductor materials (semiconductors), grown for example through LPE, MOCVD or OMVPE. The one or more semiconductors may include, but are not limited to, group III-V semiconductors, II-VI semiconductors, group IV semiconductors, and group IV-V-VI semiconductors. Examples of group III-V semiconductors may include AIP, AlN, AlGaSb, AlGaAs, AlGalnP, AlGaN, AlGaP, GaSb, GaAsP, GaAs, GaN, GaP, InAlAs, InAIP, InSb, InGaSb, InGaN, GalnAlAs, GalnAIN, GalnAsN, GalnAsP, GalnAs, GalnP, InN, InP, InAs, InAsSb, InGaAsP and AlInN. Examples of group II-VI semiconductors may include ZnSe, HgCdTe, ZnO, ZnS, and CdO. Examples of group IV Semiconductors may include Si, Ge, and strained silicon. A group IV—V-VI semiconductor may be GeSbTe.

Such semiconductors in many instances allowing monolithic integration of passive optical waveguides with active optical elements such as light emitting diodes, semiconductor optical amplifiers, laser diodes (LDs), distributed feedback LDs, external cavity laser diodes (ECLs), photodetectors (PDs) and avalanche photodetectors (APDs). For example, InGaAsP semiconductors support PDs/LDs/ECLs etc. operating in the conventional infrared telecommunication windows known as S-band (1460-1530 nm), C-band (1530-1565 nm) and L-band (1565-1625 nm).

Within embodiments of the invention the platform or substrate upon which the semiconductors are grown and processed may itself be a semiconductor, e.g., GaAs or InP, or it may within other embodiments of the invention be another material such as silicon, germanium, a ceramic, a glass and a polymer.

Within embodiments of the invention the platform or substrate upon which the integration is performed may be a silicon substrate wherein the one or more optical waveguides upon the platform exploit a silicon nitride core with silicon oxide upper and lower cladding, a waveguide structure. Alternatively, the one or more optical waveguides may employ a silicon core with silicon nitride upper and lower claddings. Optionally, the upper cladding may be omitted within other embodiments of the invention.

Embodiments of the invention may be implemented within one or more silicon-on-insulator (SOI) waveguides by way of example, e.g. air-clad Si₃N₄—SiO₂, SiO₂—Si₃N₄—SiO₂, SiO₂—Ge:SiO₂—SiO₂ or Si—SiO₂. Embodiments of the invention may be implemented with one or more waveguides such as ion exchanged glass waveguides, ion implanted glass waveguides, polymer-on-silicon waveguides, doped silicon waveguides and polymeric waveguides. Whilst not necessarily leveraging the benefits of photonic integration embodiments of the invention may also be formed using optical fibers, free-space optics, etc.

Where passive optical waveguides are employed with hybrid integration of active photonic elements, such as LDs, ECLs, PDs then these may be directly butt-coupled or they may employ intermediate coupling optics, e.g., ball lenses, spherical lenses, graded refractive index (GRIN) lenses etc. for free-space coupling and/or photonic wirebonds etc. Other waveguide structures may be employed including vertical and/or lateral waveguide tapers and forming microball lenses on the ends of the waveguides via laser and/or arc melting of the waveguide tip.

Embodiments of the invention employing optical waveguides may employ a waveguide core embedded within upper and lower claddings, a so-called buried waveguide, an air clad waveguide (i.e. a core with lower cladding and air elsewhere), a rib waveguide, a diffused waveguide, a ridge or wire waveguide, a strip-loaded waveguide, a slot waveguide, an anti-resonant reflecting optical waveguide (ARROW waveguide), a photonic crystal waveguide, a suspended waveguide, an alternating layer stack geometry, a sub-wavelength grating (SWG) waveguides or an augmented waveguide (e.g. Si—SiO₂—Polymer). Embodiments of the invention may employ a step index waveguide, a graded index waveguide or a hybrid index waveguide (such as combining inverse-step index and graded index).

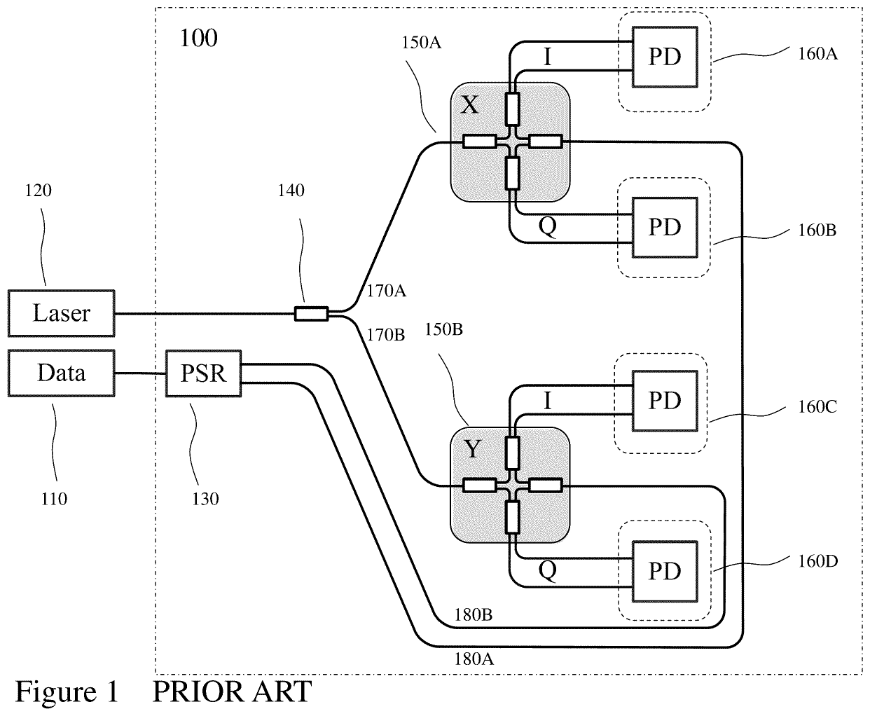

FIG. 1 depicts a polarisation diverse coherent receiver (PDCR) 100 according to the prior art. As depicted an optical signal from an optical transmitter received from an optical network the PDCR 100 is coupled to, identified as Data 110, is coupled to the PDCR 100 together with an optical local oscillator signal, Laser 120. As the optical signal Data 110 is from an optical network its polarisation is unknown and will change over time. Accordingly, the Data 110 is coupled to a polarisation splitter-rotator (PSR) 130 such that PSR 130 generates a pair of outputs wherein one output is directly split from the Data 110 with a defined polarisation whilst the other was split and rotated to the defined polarisation. As the Laser 120 is local, potentially integrated within the PDCR 100, then it emits in a single polarisation where the defined polarisation from the PSR 130 is that of the Laser 120. The optical local oscillator signal, Laser 120, is split by a Splitter 140.

One output from the PSR 130 and one output from the Splitter 140 are each coupled to first Optical Hybrid 150A whilst the other output from the PSR 130 and other output from the Splitter 140 are each coupled to second Optical Hybrid 150B.

Within first Optical Hybrid 150A the first output 180A from PSR 130 (comprising Data 110 signal) and the first output 170A from Splitter 140 (comprising Laser 120 signal) are combined generating a pair of I outputs which are coupled to a first Balanced Photodetector Pair (BPR) 160A and a pair of Q outputs which are coupled to a second BPR 160B. Within second Optical Hybrid 150B the second output 180B from PSR 130 (comprising Data 110 signal) and the second output 170B from Splitter 140 (comprising Laser 120 signal) are combined generating a pair of I outputs which are coupled to a third BPR 160C and a pair of Q outputs which are coupled to a fourth BPR 160D.

The electrical outputs from first to fourth BPRs 160A to 160D respectively are combined subsequently to generate the data encoded within the optical signal Data 110.

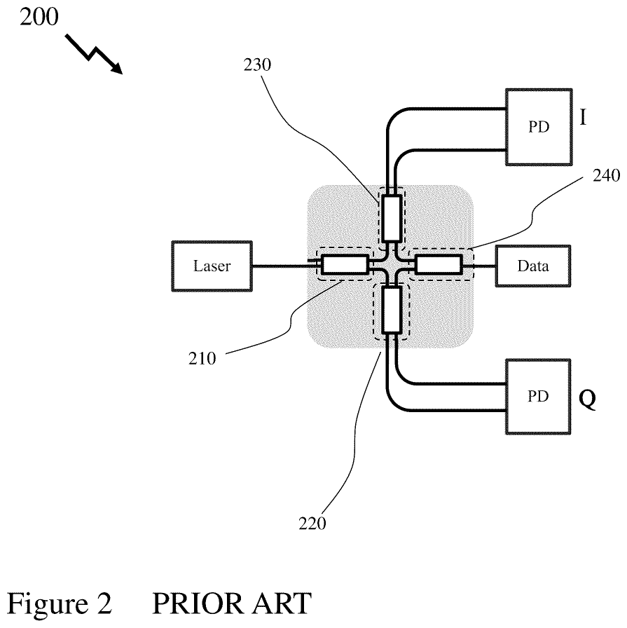

FIG. 2 depicts an optical hybrid circuit (Optical Hybrid 200) for a coherent receiver according to the prior art. Port LO is coupled to an optical local oscillator signal, e.g., Laser 120 in FIG. 1, whilst the port Signal is coupled to the received data, e.g., Data 110 in FIG. 1. The LO is coupled to a Y-junction 50:50 power splitter 210 which generates a pair of outputs with the same phase whilst Signal is coupled to a first 2×2 multi-mode interferometer (MMI) 240 which generates a pair of outputs with 90° phase difference between them. Each output comprising the optical local oscillator signal is coupled to an input of a second 2×2 MMI 220 and a third MMI 230, respectively. The other input of the second 2×2 MMI 220 and other input of the third 230 respectively being coupled to the pair of outputs of the first 2×2 MMI 220. Accordingly, the outputs of the second 2×2 MMI 220 are first and second quadrature signals Qₙ and Qₚ whilst the outputs of the third 2×2 MMI 230 are first and second in-phase signals Iₙ and Iₚ.

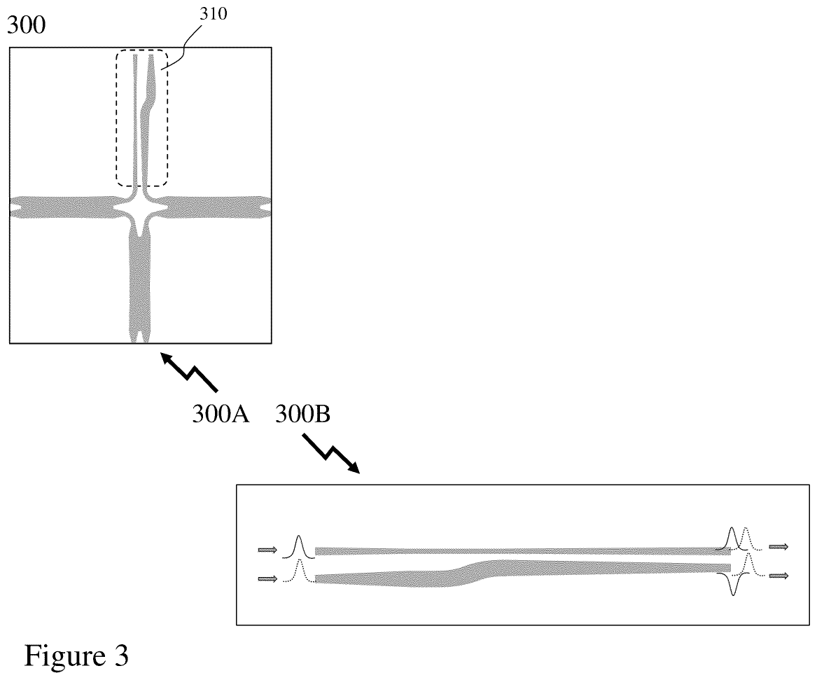

FIG. 3 depicts an optical hybrid circuit for a coherent receiver according to an embodiment of the invention. First Image 300A depicts the optical hybrid circuit (Optical Hybrid 300) wherein the Y-junction 50:50 power splitter 210 as depicted in FIG. 2 is replaced with Adiabatic 3 dB Splitter 310. Second Image 300B depicts the modal evolution within the Adiabatic 3 dB Splitter 310 for optical signals coupled to each of the input ports.

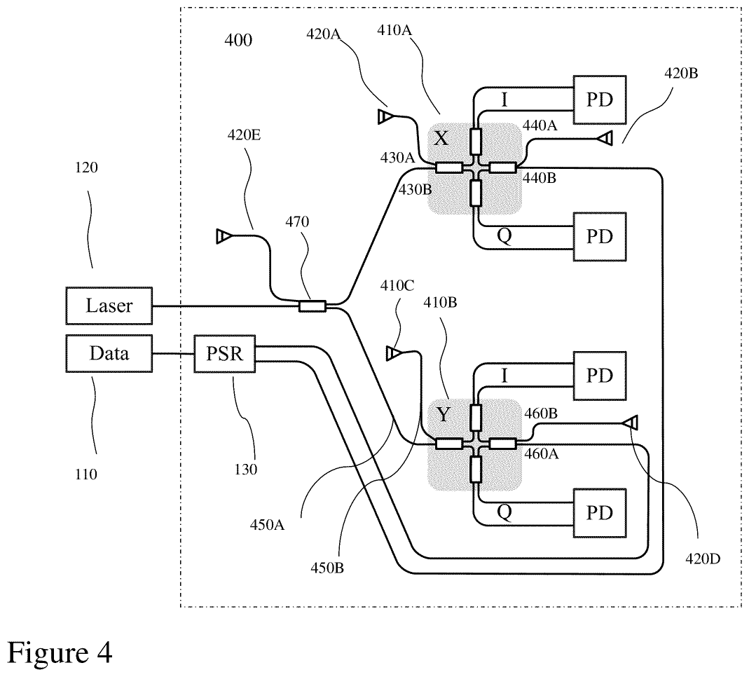

FIG. 4 depicts a polarisation diverse coherent receiver (PDCR) 400 according to an embodiment of the invention employing the inventive optical hybrid circuit depicted in FIG. 3. PDCR 400 is similar in design and operation to PDCR 100 except that now first and second Optical Hybrids 410A and 410B are employed rather than first and second Optical Hybrids 150A and 150B. Each of the first and second Optical Hybrids 410A and 410B comprising an Optical Hybrid 300. Accordingly, within first Optical Hybrid 410A now has four input ports rather than the two input ports of the first Optical Hybrid 150A.

On one side of the first Optical Hybrid 410A the first Input Port 430A is coupled to a first Test Point 420A whilst second Input Port 430B is coupled to the Laser 120 via Splitter 470. One the other side of the first Optical Hybrid 410A the third Input Port 440A is coupled to a second Test Point 420B whilst fourth Input Port 440B is coupled to the Data 110 via PSR 130.

On one side of the second Optical Hybrid 410B the first Input Port 450A is coupled to a third Test Point 420C whilst second Input Port 450B is coupled to the Laser 120 via Splitter 470. One the other side of the second Optical Hybrid 410B the third Input Port 460A is coupled to the Data 110 via PSR 130 whilst fourth Input Port 440B is coupled to a fourth Test Point 420D.

The Splitter 470 in PDCR 400 is a 2×2 splitter rather than 1×2 Splitter 140 in PDCR 100. Accordingly, the other input port of the Splitter 470 is coupled to fifth Test Point 420E.

Each of the first to fifth Test Points 420F may be a surface grating coupler, a facet of an optical waveguide for butt-coupling to an optical fiber or a photonic wirebond interface such as described within PCT/CA2022/051004 “Printed Photonic Component based Photonic Device Probing and Testing” for example.

Within another embodiment of the invention the first and second Input Ports 430A and 430B respectively of first Optical Hybrid 410A and/or the first and second Input Ports 450A and 450B respectively of the second Optical Hybrid 410B may be configured in reverse such that first Input Port 430A of first Optical Hybrid 410A and first Input Port 450A of the second Optical Hybrid 410B are coupled to the Laser 120 via Splitter 470 whilst the second Input Port 430B of first Optical Hybrid 410A and second Input Port 450B of the Optical Hybrid 410B are coupled to first and third Test Points 420A and 420C respectively.

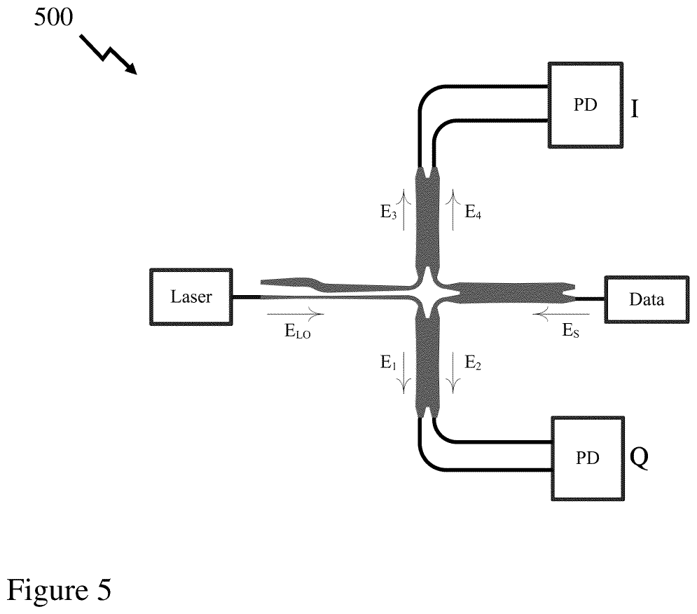

Referring to FIG. 5 there is depicted an optical hybrid circuit (Optical Hybrid 500) for a coherent receiver according to an embodiment of the invention. Accordingly, the Optical Hybrid 500 generates four output signals E₁, E₂, E₃, E₄ in dependence upon local oscillator and signal inputs E_{LO} and Eₛ respectively. The transfer matrices for the Optical Hybrid 500 being E₁ and E₁ as given by Equations (1) to (3) below.

$${T}_{1} = \sqrt{κ} [ \begin{matrix}1 & 0 & 0 & 0 \\ 0 & 1 & 0 & 0 \\ 0 & {e}^{j π} & 0 & 0 \\ {e}^{\frac{j π}{2}} & 0 & 0 & 0\end{matrix} ] {T}_{2} = \sqrt{κ} [ \begin{matrix}1 & {e}^{\frac{j π}{2}} & 0 & 0 \\ {e}^{\frac{j π}{2}} & 1 & 0 & 0 \\ 0 & 0 & 1 & {e}^{\frac{j π}{2}} \\ 0 & 0 & {e}^{\frac{j π}{2}} & 1\end{matrix} ] \qquad ( 1 )$$

$$[ \begin{matrix}{E}_{1} \\ {E}_{2} \\ {E}_{3} \\ {E}_{4}\end{matrix} ] = {T}_{2} . {T}_{1} . [ \begin{matrix}{E}_{s} \\ {E}_{LO} \\ 0 \\ 0\end{matrix} ] \qquad ( 2 )$$

$$[ \begin{matrix}{E}_{1} \\ {E}_{2} \\ {E}_{3} \\ {E}_{4}\end{matrix} ] = κ [ \begin{matrix}{E}_{S} + {jE}_{LO} \\ j ( {E}_{S} - {jE}_{LO} ) \\ - ( {E}_{S} + {E}_{LO} ) \\ j ( {E}_{S} - {E}_{LO} )\end{matrix} ] = κ [ \begin{matrix}1 & {e}^{\frac{j π}{2}} & 0 & 0 \\ {e}^{\frac{j π}{2}} & 1 & 0 & 0 \\ 0 & 0 & 1 & {e}^{\frac{j π}{2}} \\ 0 & 0 & {e}^{\frac{j π}{2}} & 1\end{matrix} ] [ \begin{matrix}{E}_{s} \\ {E}_{LO} \\ {e}^{j π} {E}_{LO} \\ {e}^{\frac{j π}{2}} {E}_{s}\end{matrix} ] ← \sqrt{κ} [ \begin{matrix}{E}_{s} \\ {E}_{LO} \\ {e}^{j π} {E}_{LO} \\ {e}^{\frac{j π}{2}} {E}_{s}\end{matrix} ] = \sqrt{κ} [ \begin{matrix}1 & 0 & 0 & 0 \\ 0 & 1 & 0 & 0 \\ 0 & {e}^{j π} & 0 & 0 \\ {e}^{\frac{j π}{2}} & 0 & 0 & 0\end{matrix} ] [ \begin{matrix}{E}_{s} \\ {E}_{LO} \\ 0 \\ 0\end{matrix} ] \qquad ( 3 )$$

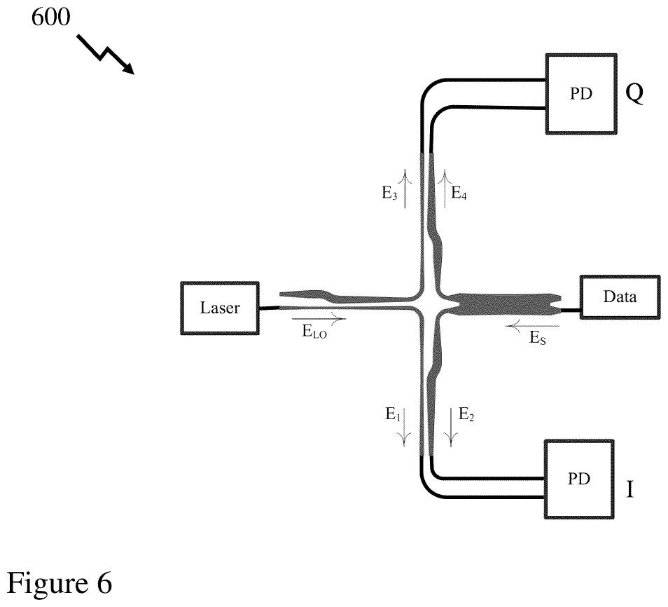

Referring to FIG. 6, there is depicted an optical hybrid circuit (Optical Hybrid 600) for a coherent receiver according to an embodiment of the invention. Accordingly, the Optical Hybrid 600 generates four output signals E₁, E₂, E₃, E₄ in dependence upon local oscillator and signal inputs E_{LO} and Eₛ respectively. The transfer matrices for the Optical Hybrid 600 being E₁ and E₁ as given by Equations (4) to (6) below.

$${T}_{1} = \sqrt{κ} [ \begin{matrix}1 & 0 & 0 & 0 \\ 0 & 1 & 0 & 0 \\ 0 & {e}^{j π} & 0 & 0 \\ {e}^{\frac{j π}{2}} & 0 & 0 & 0\end{matrix} ] {T}_{2} = \sqrt{κ} [ \begin{matrix}1 & {e}^{j π} & 0 & 0 \\ 1 & 1 & 0 & 0 \\ 0 & 0 & 1 & 1 \\ 0 & 0 & {e}^{j π} & 1\end{matrix} ] \qquad ( 4 )$$

$$[ \begin{matrix}{E}_{1} \\ {E}_{2} \\ {E}_{3} \\ {E}_{4}\end{matrix} ] = {T}_{2} . {T}_{1} . [ \begin{matrix}{E}_{s} \\ {E}_{LO} \\ 0 \\ 0\end{matrix} ] \qquad ( 5 )$$

$$[ \begin{matrix}{E}_{1} \\ {E}_{2} \\ {E}_{3} \\ {E}_{4}\end{matrix} ] = κ [ \begin{matrix}{E}_{S} - {E}_{LO} \\ {E}_{S} + {E}_{LO} \\ j ( {E}_{S} + {jEL}_{0} ) \\ j ( {E}_{S} - {jEL}_{0} )\end{matrix} ] = κ [ \begin{matrix}1 & {e}^{j π} & 0 & 0 \\ 1 & 1 & 0 & 0 \\ 0 & 0 & 1 & 1 \\ 0 & 0 & {e}^{j π} & 1\end{matrix} ] [ \begin{matrix}{E}_{s} \\ {E}_{LO} \\ {e}^{j π} {E}_{LO} \\ {e}^{\frac{j π}{2}} {E}_{s}\end{matrix} ] ← \sqrt{κ} [ \begin{matrix}{E}_{s} \\ {E}_{LO} \\ {e}^{j π} {E}_{LO} \\ {e}^{\frac{j π}{2}} {E}_{s}\end{matrix} ] = \sqrt{κ} [ \begin{matrix}1 & 0 & 0 & 0 \\ 0 & 1 & 0 & 0 \\ 0 & {e}^{j π} & 0 & 0 \\ {e}^{\frac{j π}{2}} & 0 & 0 & 0\end{matrix} ] [ \begin{matrix}{E}_{s} \\ {E}_{LO} \\ 0 \\ 0\end{matrix} ] \qquad ( 6 )$$

In addition to addressing improvements within photonic coherent receivers the inventors have also identified an improved design for modulators to address velocity matching between the modulating electrical signal and the optical signal. Within a travelling wave (TW) MZI modulator then there are two competing tradeoffs, the reducing drive achievable by increasing the device length and increasing modulation bandwidth with reducing device length. By improving the velocity match between the travelling wave electrical signal and the propagating optical signal then the bandwidth can be increased for a given length allowing reduced voltage for a given bandwidth. Within silicon photonics the effective index of a TW electrode is higher than that of the optical waveguide such that the optical signal propagates faster.

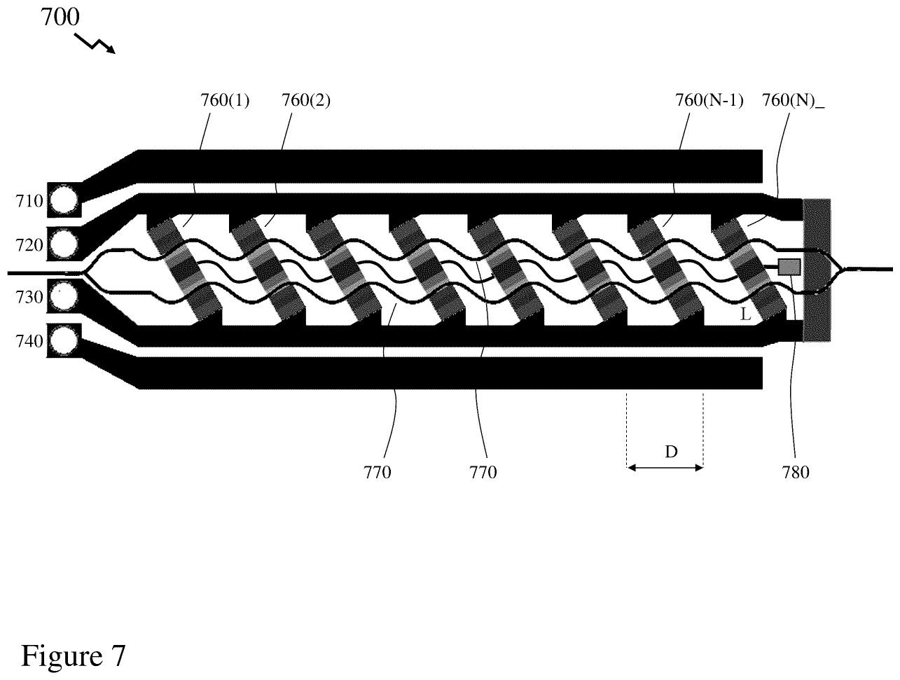

Accordingly, the inventors as depicted in FIG. 7 have established a periodic structure to provide a periodic adjustment to phase match the optical and electrical signals. As depicted in FIG. 7 with Schematic 700 a coplanar waveguide TW electrode is depicted comprising inner Signal Lines 720 and 730 with outer Ground Lines 710 and 740. Disposed periodically along the structure are Contacts 760(1) to 760(N) disposed and electrically connected to the Signal Lines 720 and 730. In order to slow the optical signal, the pair of optical waveguides 770 employ a periodic sinusoidal geometry such the optical path length between each adjacent pair of Contacts 760(1) to 760(N) is longer than the physical distance between them thereby providing for improved phase matching and thereby increased modulation bandwidth for the modulator employing the TW electrode.

The spacing, D, between each pair of Contacts 760(1) to 760(N) is established in dependence upon one or more factors selected from the group comprising the velocity mismatch of the electrical and optical signals, the velocity of the optical signal, the velocity of the electrical signal, the target bandwidth of the modulator and the length of the modulator comprising the first Contacts 760(1) to 760(N). A second Contact 780 provides the other contact such that current flows from the first Contacts 760(1) to 760(N) to the second Contact 780 thereby adjusting its refractive index.

It would be evident that different drive schemes and material characteristics may be employed to effect the change in refractive index via a plurality of contacts disposed along the length of the TW electrode.

The length, L, of each contact of the first Contacts 760(1) to 760(N) is established in dependence upon one or more factors selected from the group comprising the velocity mismatch of the electrical and optical signals, the velocity of the optical signal, the velocity of the electrical signal, the target bandwidth of the modulator and the length of the modulator comprising the first Contacts 760(1) to 760(N). Within embodiments of the invention the length L may be constant for all contacts of the first Contacts 760(1) to 760(N) or it may vary such that the length of the contacts within the first Contacts 760(1) to 760(N) is adjusted according to a defined mathematical function established in dependence upon one or more factors selected from the group comprising the velocity mismatch of the electrical and optical signals, the velocity of the optical signal, the velocity of the electrical signal, the target bandwidth of the modulator, the length of the modulator comprising the first Contacts 760(1) to 760(N) and the attenuation of the TW electrode

The optical waveguide as depicted in FIG. 7 has a periodic sinusoidal offset from a linear axis of the MZI modulator from the input splitter (depicted as a Y-junction in FIG. 7) to the output splitter (also depicted as Y-junction in FIG. 7). Within other embodiments of the invention the axis of the modulator may be non-linear or linear such as defined by a mathematical function for example, e.g., linear, a portion of a circle, a portion of an ellipse etc. between the start and end of the section with the first Contacts 760(1) to 760(N).

The optical waveguide as depicted in FIG. 7 has a periodic sinusoidal offset from a linear axis of the MZI modulator from the input splitter (depicted as a Y-junction in FIG. 7) to the output splitter (also depicted as Y-junction in FIG. 7). Within other embodiments of the invention the periodic offset may be defined by another mathematical function.

It would be evident to one of skill in the art that the phase matching scheme may be applied to phase modulators as well as amplitude modulators or applied to other amplitude modulator geometries.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. An optical circuit comprising:
an adiabatic coupler having a pair of input ports and a pair of output ports;
a first coupler having an input port coupled to an output port of the pair of output ports of the adiabatic coupler;
a second coupler having an input port coupled to another output port of the pair of output ports of the adiabatic coupler; and
a third coupler having a pair of input ports and a pair of output ports; wherein an output port of the pair of output ports of the third coupler is coupled to another input port of the first coupler;
another output port of the pair of output ports of the third coupler is coupled to another input port of the second coupler;
a pair of output ports of the first coupler are coupled to a first balanced photodetector; and
a pair of output ports of the second coupler are coupled to a second balanced photodetector.

2. The optical circuit according to claim 1, further comprising
at least one of:
a photonic test point coupled to the other input port of the adiabatic coupler for coupling test optical signals to the optical circuit; and
another photonic test point coupled to the other input port of the third coupler for coupling other test optical signals to the optical circuit.

3. A method of receiving optical data comprising:
providing an optical circuit comprising a pair of optical hybrid circuits each comprising:
an adiabatic coupler having a pair of input ports and a pair of output ports;
a first coupler having an input port coupled to an output port of the pair of output ports of the adiabatic coupler;
a second coupler having an input port coupled to another output port of the pair of output ports of the adiabatic coupler; and
a third coupler having a pair of input ports and a pair of output ports; wherein
an output port of the pair of output ports of the third coupler is coupled to another input port of the first coupler;
another output port of the pair of output ports of the third coupler is coupled to another input port of the second coupler;
a pair of output ports of the first coupler are coupled to a first balanced photodetector; and
a pair of output ports of the second coupler are coupled to a second balanced photodetector
providing a splitter coupled to a laser emitting at a predetermined wavelength with a predetermined polarisation wherein a first output of the splitter is coupled to an input port of the pair of input ports of the adiabatic coupler within an optical hybrid circuit of the pair of optical hybrid circuits and a second output of the splitter is coupled to an input port of the pair of input ports of the adiabatic coupler within the other optical hybrid circuit of the pair of optical hybrid circuits;
providing a polarisation splitter and rotator (PSR) circuit coupled to a network for receiving an optical signal at the predetermined wavelength wherein a first output of the PSR circuit is split from the received optical signal with the PSR circuit has the predetermined polarisation and is coupled to an input port of the third coupler of an optical hybrid circuit of the pair of optical hybrid circuits and a second output of the PSR circuit is split from the received optical signal with an orthogonal polarisation to the predetermined polarisation and rotated to the predetermined polarisation prior to becoming the second output of the PSR circuit and is coupled an input port of the third coupler within the other optical hybrid circuit of the pair of optical hybrid circuits.

4. The method according to claim 3, wherein
at least one optical hybrid circuit of the pair of optical hybrid circuits comprises at least one of:
a photonic test point coupled to the other input port of the adiabatic coupler for coupling test optical signals to the optical hybrid circuit; and
another photonic test point coupled to the other input port of the third coupler for coupling other test optical signals to the optical hybrid circuit.

5. An optical circuit comprising:
an adiabatic coupler having a pair of input ports and a pair of output ports;
a first coupler having an input port coupled to an output port of the pair of output ports of the adiabatic coupler;
a second coupler having an input port coupled to another output port of the pair of output ports of the adiabatic coupler; and
a third coupler having a pair of input ports and a pair of output ports; wherein
an output port of the pair of output ports of the third coupler is coupled to another input port of the first coupler; and
another output port of the pair of output ports of the third coupler is coupled to another input port of the second coupler.

6. The optical circuit according to claim 5, further comprising
a first balanced photodetector coupled to a pair of output ports of the first coupler; and
a second balanced photodetector coupled to a pair of output ports of the second coupler.

7. The optical circuit according to claim 5, further comprising
at least one of:
a photonic test point coupled to the other input port of the adiabatic coupler for coupling test optical signals to the optical circuit; and
another photonic test point coupled to the other input port of the third coupler for coupling other test optical signals to the optical circuit.

8. A device comprising:
an optical waveguide;
a travelling wave electrode for inducing a phase shift to an optical signal propagating within the optical waveguide comprising a plurality of contacts disposed along a section of the optical waveguide; wherein
the optical waveguide has a periodic offset by a mathematical function along the length of the section of the optical waveguide from an overall path of the optical waveguide which is defined by another mathematical function over the length of the section of the optical waveguide; and
the period of the periodic offset is defined in dependence upon a spacing between adjacent pairs of contacts of the plurality of contacts.

9. The device according to claim 8, wherein
a spacing between each pair of contacts of the plurality of contacts is established in dependence upon one or more factors selected from the group comprising a velocity mismatch of the electrical and optical signals, a velocity of the optical signal, a velocity of the electrical signal, a target bandwidth of the modulator and a length of the plurality of contacts.

10. The device according to claim 8, wherein
a length of each contact of the plurality of contacts is established in dependence upon one or more factors selected from the group comprising a velocity mismatch of the electrical and optical signals, a velocity of the optical signal, a velocity of the electrical signal, a target bandwidth of the modulator and a length of the plurality of contacts.

11. The device according to claim 8, wherein
a nominal length each contact of the plurality of contacts is established in dependence upon one or more factors selected from the group comprising a velocity mismatch of the electrical and optical signals, a velocity of the optical signal, a velocity of the electrical signal, a target bandwidth of the modulator and a length of the plurality of contacts; and
the length of each contact of the plurality of contacts is adjusted according to another mathematical function established in dependence upon one or more factors selected from the group comprising the velocity mismatch of the electrical and optical signals, the velocity of the optical signal, the velocity of the electrical signal, the target bandwidth of the modulator, the length of the modulator comprising the plurality of contacts and the attenuation of the TW electrode.
